(19) United States
(12) Patent Application Publication
(10) Pub. No.: US 2002/0132665 A1
(43) Pub. Date: Sep. 19, 2002

(54) Image processing apparatus, image processing program, and recording medium having the program recorded thereon

(75) Inventor: Masanori Kato, Tokyo (JP)

Correspondence Address: LYON & LYON LLP, 633 WEST FIFTH STREET, SUITE 4700, LOS ANGELES, CA, 90071, US

(73) Assignee: Namco Ltd.

(21) Appl. No.: 10/097,650

(22) Filed: Mar. 15, 2002

(30) Foreign Application Priority Data
Mar. 19, 2001 (JP) 2001-079231

(51) Int. Cl. A63F 13/00

(52) U.S. Cl. 463/30

(57) ABSTRACT

An object and an aiming mark are displayed on a monitor. The position of the aiming mark is moved in accordance with a movement instruction output from a controller. On the basis of movement of the aiming mark, a determination is made as to whether or not the aiming mark has been actuated toward the object. If the aiming mark is determined to have been actuated toward the object, the aiming mark is automatically drawn to a position where the mark points at the object.

### BACKGROUND OF THE INVENTION

1. Field of the Invention

The present invention relates to an image processing apparatus, an image processing program, and a recording medium having the program recorded thereon, and more particularly, to an image processing apparatus, an image processing program, and a recording medium having the program recorded thereon which are suitable for application to a shooting game which handles objects appearing on a monitor as targets.

2. Description of the Background Art

There has hitherto been known a shooting game in which a player uses a pointing device such as a gun-type controller (hereinafter called simply a “gun controller”) to attack enemies appearing on a monitor. In order to offer such a shooting game on the market as a household game, the shooting game must be compatible with a general-purpose game controller as well as with a custom-designed pointing device.

A pointing device, such as a gun controller, is a device suitable for quickly pointing at any point on the monitor. In contrast, a general-purpose game controller is not necessarily a device suitable for such pointing action. Hence, when a general-purpose game controller is used with a related-art shooting game, there arises a problem of difficulty in offering comfortable operability to a user.

### SUMMARY OF THE INVENTION

The present invention has been conceived to solve the above-described problem and primarily aims at providing an image processing apparatus which facilitates an operation to be performed when a user points at an object on a monitor with use of a pointing mark.

The present invention also aims at providing a program for implementing the image processing apparatus on a computer.

The present invention further aims at providing a computer-readable recording medium having the program recorded thereon.

The above objects of the present invention are achieved by an image processing apparatus. The apparatus includes an object display unit for displaying an object on a monitor, unit for displaying a pointing mark on the monitor, and unit for moving the position of the pointing mark on the monitor in accordance with a movement instruction output from a controller. The apparatus also includes a determination unit for determining, on the basis of movement of the pointing mark, whether or not the pointing mark is actuated toward the object. The apparatus further includes a drawing unit for drawing the pointing mark to a drawing position which links with the object when the pointing mark is determined to have been actuated toward the object.

The above objects of the present invention are achieved by an image processing program. The program causes a computer to perform object display processing for displaying an object on a monitor, processing for displaying a pointing mark on the monitor, and processing for moving the position of the pointing mark on the monitor in accordance with a movement instruction output from a controller. The program also causes the computer determination processing for determining, on the basis of movement of the pointing mark, whether or not the pointing mark is actuated toward the object. The program further causes the computer drawing processing for drawing the pointing mark to a drawing position which links with the object when the pointing mark is determined as being actuated toward the object.

The above objects of the present invention are achieved by a computer-readable recording medium recorded thereon the image processing program defined above.

Other objects and further features of the present invention will be apparent from the following detailed description when read in conjunction with the accompanying drawings.

### BRIEF DESCRIPTION OF THE DRAWINGS

FIG. 1 is a conceptual rendering showing the configuration of a game system according to the first embodiment of the present invention;

FIGS. 2A and 2B are illustrations for describing characteristics of a shooting game performed by a game machine according to the first embodiment of the present invention;

FIG. 3 is a flowchart pertaining to a round of processing steps to be performed by the game machine according to the first embodiment of the present invention;

FIGS. 4A and 4B are illustrations for describing characteristics of a shooting game performed by a game machine according to a second embodiment of the present invention;

FIG. 5 is a flowchart pertaining to a round of processing steps to be performed by the game machine according to the second embodiment of the present invention;

FIGS. 6A and 6B are illustrations for describing characteristics of a shooting game performed by a game machine according to a third embodiment of the present invention;

FIG. 7 is a view for describing a Z value set for an object appearing on a monitor of a game machine according to a fourth embodiment of the present invention;

FIGS. 8A and 8B are illustrations for describing characteristics of a shooting game performed by a game machine according to a fifth embodiment of the present invention;

FIG. 9 is a flowchart pertaining to a round of processing steps to be performed by the game machine according to the fifth embodiment of the present invention;

FIG. 10 is a flowchart pertaining to a round of processing steps to be performed by the game machine according to a sixth embodiment of the present invention;

FIG. 11 is a flowchart pertaining to a round of processing steps to be performed by the game machine according to a seventh embodiment of the present invention; and

FIG. 12 is a flowchart pertaining to a round of processing steps to be performed by the game machine according to an eighth embodiment of the present invention.

### DESCRIPTION OF THE PREFERRED EMBODIMENTS

First Embodiment.

A game system according to a first embodiment of the present invention will be described hereinbelow by reference to the accompanying drawings.

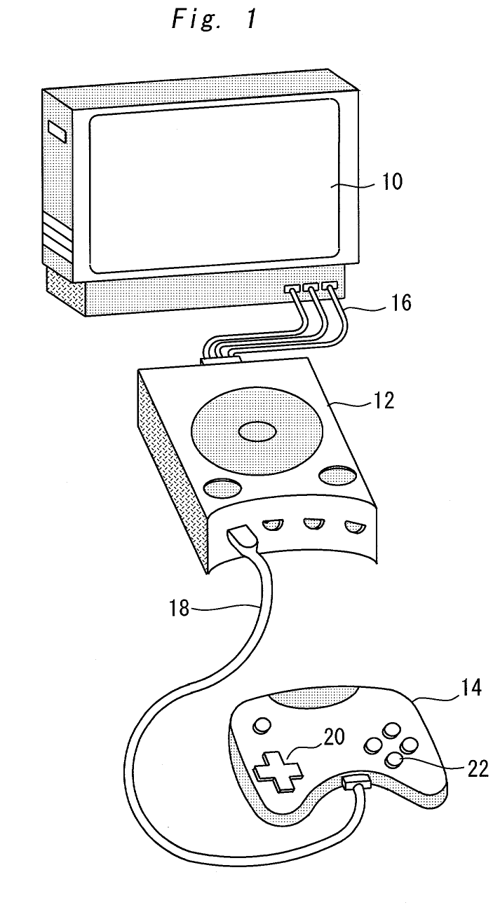

FIG. 1 is a conceptual rendering showing the configuration of a game system according to the present embodiment. As shown in FIG. 1, the game system according to the present embodiment has a monitor 10, such as a TV set; a game machine 12; and a game controller 14. The monitor 10 and the game machine 12 are connected together by means of output cables 16. Further, the game machine 12 and the game controller 14 are interconnected by way of an input cable 18. The game controller 14 is provided with a direction button 20 and various types of buttons 22 which are to be used when the user performs an input operation.

A recording medium (not shown), such as a CD-ROM, is housed in the game machine 12. A program required for executing a shooting game to be described later is recorded on the recording medium. By means of executing the program, the game machine 12 effects progress in the shooting game in accordance with an instruction issued by the game controller 14.

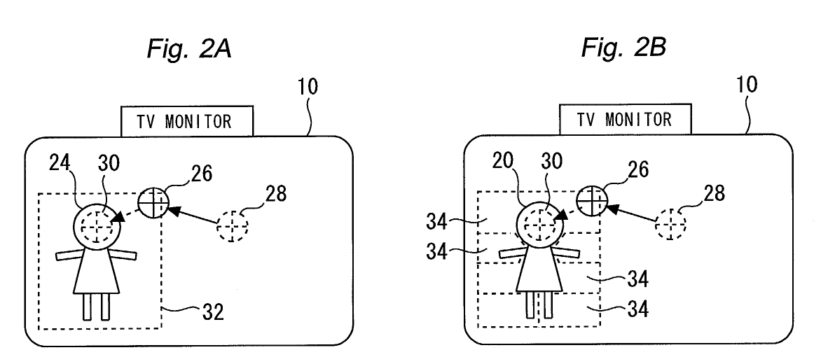

FIGS. 2A and 2B are illustrations for describing characteristics of the shooting game performed by the game machine 12 in the present embodiment. As shown in FIG. 2A, the game machine 12 displays, on the monitor 10, an object 24 which becomes a target of the shooting game. The game machine 12 displays, on the monitor 10, a pointing mark to be used for pointing at an arbitrary point on the monitor 10; that is, an aiming mark 26 to be used in the shooting game.

In accordance with the instruction signal output from the controller 14, the game machine 12 moves the position of the aiming mark 26 on the monitor 10. The user can move the position of the aiming mark 26 arbitrarily over the monitor 10 by means of actuating the direction button 20 of the controller 14.

In response to a trigger signal output from the controller 14, the game machine 12 performs processing for causing the position of the aiming mark 26 to be shot. More specifically, when the user performs a triggering operation (i.e., actuation of the button 22), the game machine 12 performs processing for displaying an animation showing that the position of the aiming mark 26 is shot or for effecting sound effects, such as the sound of a shot.

The game machine 12 determines whether or not an object 24 on the monitor 10 is shot, by means of comparing the position of an impact area and the object 24. In accordance with the state of the object 24 being shot, an animation is displayed or sound effects are produced to represent the state.

The game machine 12 performs predetermined processing in accordance with the program stored in the recording medium, thereby implementing the foregoing function appropriately. Thus, the game system shown in FIG. 1 enables the user to enjoy playing a shooting game by aligning the aiming mark 26 to the target and shooting it.

In the shooting game performed by the game system according to the present embodiment, after the object 24 has appeared at an arbitrary position on the monitor 10, the user is required to promptly align the aiming mark 26 to the object 24 and perform a triggering action. However, it is not necessarily easy to promptly and accurately move the aiming mark 26 from one arbitrary point to another arbitrary point over the monitor 10 by means of actuating the direction button 20. In the present embodiment, in order to make it easy for the user to align the aiming mark 26 to the object 24, the game machine 12 performs a drawing operation to be described below.

A symbol designated by a broken line and assigned reference numeral 28 shown in FIG. 2A shows the position where the aiming mark 26 has been present in the past; that is, a past aiming position. Another symbol designated by a broken line and assigned reference numeral 30 shows the position of the aiming mark 26 after having been drawn through a drawing operation; that is, a drawn aiming position.

On the basis of the past aiming position 28 and the current position of the aiming mark 26, the game machine 12 according to the present invention ascertains the movement (trail) of the aiming mark 26. On the basis of the movement, the game machine 12 determines whether or not an operation is performed such that the aiming mark 26 is aimed at the object 24. Details of a determination operation to be performed in this phase will be described later. When the game machine 12 determines that the operation has been performed such that the aiming mark 26 is aimed at the object 24, the aiming mark 26 is automatically drawn to the drawn aiming position 30 shown in FIG. 2A.

The drawn aiming position 30 is one where if the aiming mark 26 locates, the game machine 12 determines that the object 24 is pointed by the mark 26. More specifically, the drawn aiming position 30 is one at which the game machine 12 ascertains a hit on the object 24 if a triggering action is performed while the aiming mark 26 is placed on that position.

In some instances, a hit box larger than the object 24 is set for the object 24 which is a target of the shooting game. The hit box is a remedy for alleviating the difficulty of the shooting game by means of virtually making a target larger. More specifically, the hit box is a remedy for effecting progress in a game as if a bullet virtually fired in the shooting game has hit the object 24 when the hit box is hit. It is important that the drawn aiming position 30 is set on the monitor 10 at a position overlapping with the hit box.

In a case where the drawn aiming position 30 overlaps with the hit box but does not overlap with the object 24, the aiming mark 26 are shown after the drawing operation has been performed at a position at which the aiming mark 26 does not overlap with the object 24. In this case, there may arise a case where a hit on the object 24 may be determined in spite of the aiming mark 26 not being aimed at the object 24, which is likely to afford a strange feeling to the user.

In the present embodiment, the drawn aiming position 30 is set so as to overlap with the object 24. By means of such settings, the aiming mark 26 is always displayed at a position where it overlaps with the object 24 after a drawing operation has been performed. A game can be caused to proceed without affording strange feeling to the user while the aiming operation to be performed through use of the game controller 14 is made easy.

When the object 24 which acts as a target moves at high speed, use of the above-described remedy method; that is, a method of setting a hit box which is larger than an object, is useful to increase a hit rate. Under such a circumstance, even if a hit is determined in spite of the fact that the aiming mark 26 is not aimed at the object 24, significant strange feeling is not afforded to the user. In a case where a hit box larger than the object 24 which moves at high speed is set, drawing the aiming mark 26 to a position where it overlaps the object 24 is not necessarily required; the only requirement is that the aiming mark 26 be drawn to a position where it overlaps the hit box.

Next will be described a method of determining whether or not an operation is performed such that the aiming mark 26 is aimed at the object 24.

As shown in FIG. 2A, in order to perform the foregoing determination, the game machine 12 sets predetermined drawing areas 32 to enclose corresponding objects 24 appearing on the monitor 10 such that the areas 32 become larger than the objects 24. When the aiming mark 26 has entered one of the drawing areas 32, the game machine 12 determines that the aiming mark 26 has been moved so as to aim at the object 24.

FIG. 2A shows a case where only one drawing area 32 is provided for one object 24. In contrast, FIG. 2B shows a case where a plurality of drawing areas 34 are set for one object 24. As shown in FIG. 2B, the respective drawing areas 34 are assigned to parts of the object 24 (e.g., the head, the body, arms, and legs).

The game machine 12 can selectively set either the drawing area 32 shown in FIG. 2A or the drawing areas 34 shown in FIG. 2B, as required. When the drawing areas 34 shown in FIG. 2B are set, upon entering any of the drawing areas 34 the aiming mark 26 is automatically drawn to a position where the aiming mark 26 overlaps the part assigned to the drawing area 34 of interest. This enables execution of more sophisticated processing in which individual parts of the object 24 are taken as independent targets, and the effect of impact is caused to differ from one part to another part.

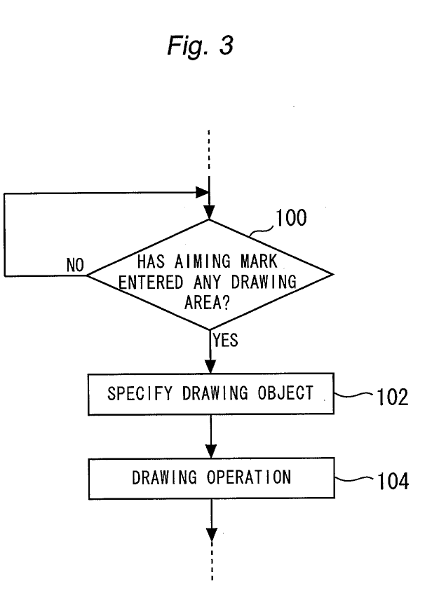

FIG. 3 is a flowchart pertaining to a round of processing steps to be performed by the game machine 12 for implementing the foregoing drawing operation.

As shown in FIG. 3, the game machine 12 firstly determines whether the aiming mark 26 has entered any drawing area (step 100).

If the aiming mark 26 is determined to have entered a drawing area, the area which the aiming mark 26 has entered is then specified (step 102).

Next, there is performed processing for automatically drawing the aiming mark 26 to the drawn aiming position 30 corresponding to the thus-specified drawing area. That is, processing for drawing the aiming mark 26 is performed (step 104).

In the present embodiment, during the course of progress in the shooting game the game machine 12 repeatedly performs processing pertaining to steps 100 through 104. Through use of the direction button 22, the user moves the aiming mark 26 to a position in the vicinity of the object 24 appearing on the monitor 10, thereby readily aiming the aiming mark 26 at the object 24 or a desired part of the object 24. Accordingly, the game machine 12 according to the present embodiment provides the user with a shooting game which enables comfortable aiming action under a situation in which the general-purpose game controller 14 is used.

Second Embodiment.

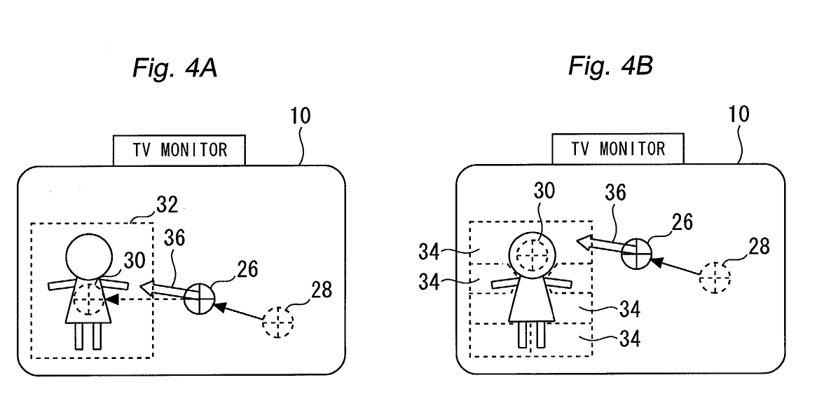

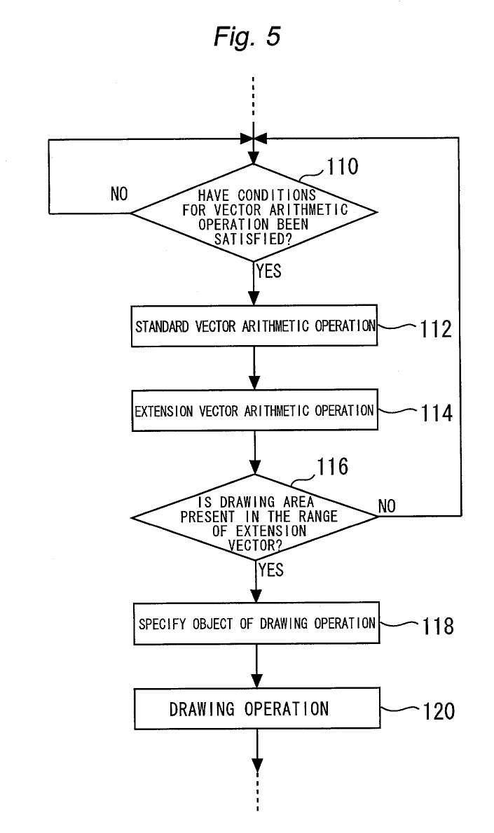

A second embodiment of the present invention will now be described by reference to FIGS. 4 and 5.

FIGS. 4A and 4B are illustrations for describing a characteristic of a shooting game to be provided by the game machine 12 according to the second embodiment. More specifically, FIG. 4A shows an illustration for describing the operation of the game machine 12 when one drawing area 32 is set for the object 24, and FIG. 4B shows an illustration for describing the operation of the game machine 12 when a plurality of drawing areas 34 are set for the object 24. As in the case of the first embodiment, the game machine 12 can selectively set either the drawing area 32 shown in FIG. 4A or the drawing areas 34 shown in FIG. 4B for the object 24, as required.

The game machine 12 according to the present embodiment is identical with that described in connection with the first embodiment, except that it employs a different method of determining whether or not the aiming mark 26 is operated so as to aim at the object 24. For this reason, primarily the method to be executed by the game machine 12 according to the present embodiment for enabling determining operation will be described.

An outlined arrow 36 shown in FIGS. 4A and 4B shows an extension vector determined on the basis of a past trail of the aiming mark 26. The extension vector 36 is oriented toward a direction in which the aiming mark 26 is expected to move and has a magnitude corresponding to an expected travel speed of the aiming mark 26. The game machine 12 according to the present embodiment determines whether or not the aiming mark 26 is operated so as to aim at the object 24, in accordance with a result of a determination as to whether or not the extension vector 36 has entered the drawing area 32 (or 34).

FIG. 5 is a flowchart for describing a round of operations required when the game machine 12 according to the present embodiment performs a determination operation and an operation for drawing the aiming mark 26 on the basis of the result of determination.

As shown in FIG. 5, the game machine 12 according to the embodiment firstly determines whether or not conditions for a vector arithmetic operation have been satisfied (step 110).

Conditions for vector arithmetic operation are those that become viable in a situation which requires a calculation of a standard vector representing the traveling direction and speed of the aiming mark 26. More specifically, these conditions are determined to be satisfied under a situation in which the user desires to start a drawing operation.

When the user desires to promptly aim the aiming mark 26 at the object 24, the user firmly actuates the direction button 20 such that the aiming mark 26 aims at the object 24. Further, the user stops actuating the direction button 20 at a timing when an overlap exists between the aiming mark 26 and the object 24. Hence, when the operation for actuating the direction button 20 is stopped, it can be estimated that the user desires to align the aiming mark 26 to the object 24; namely, that the user desires to start a drawing operation. For this reason, when the aiming mark 26 has ceased its movement or when an input operation performed by way of the direction button 20 has disappeared, the user can be estimated to desire start of a drawing operation at that timing.

When the game machine 12 according to the present embodiment is equipped with a drawing start button, the user who desires to align the aiming mark 26 to the object 24 is considered to actuate the drawing start button. For this reason, when the drawing start button is actuated, it can be presumed that the user desires commencement of a drawing operation at that timing.

In the present embodiment, in step 110, (1) when the operation performed by way of the direction button 20 is determined to have been ceased, (2) when the aiming mark 26 is determined to have stopped, or (3) when the user has actuated the drawing start button, conditions for vector arithmetic operation are determined to have been satisfied.

When the conditions for vector arithmetic operation are determined to have been satisfied, a standard vector representing the moving direction and speed of the aiming mark 26 is computed (step 112).

In the present embodiment, the game machine 12 detects the position of the aiming mark 26 for each predetermined processing interval and stores aiming positions corresponding to a predetermined number of past intervals. In step 112, the direction of the standard vector is determined on the basis of aiming positions for the latest two intervals as counted back from the point in time at which the conditions for vector arithmetic operation have been satisfied. In step 112, the magnitude of the standard vector is also determined on the basis of aiming positions corresponding to a predetermined number of intervals (three or more) as counted back from the point in time at which the conditions for vector arithmetic operation have been satisfied. By means of such an arithmetic operation method, the moving direction and speed of the aiming mark obtained at a point in time in which conditions for vector arithmetic operation are satisfied can be accurately reflected in a standard vector.

When the direction and magnitude of the standard vector have been calculated in the manner as mentioned above, the extension vector 36 shown in FIGS. 4A and 4B are computed on the basis of the direction and magnitude of the standard vector. More specifically, there is computed an extension vector which is oriented in the same direction as the standard vector and which has a magnitude equal to a multiple of the standard vector (step 114).

Next, the game machine 12 according to the embodiment determines whether or not the extension vector 36 has entered any one of the drawing areas (step 116).

When the extension vector 36 is determined to have entered any one of the drawing areas, the drawing area is specified (step 118).

The aiming mark 26 is automatically drawn to the drawn aiming position 30 corresponding to the thus-specified drawing area (step 120).

In the embodiment, during the course of progress in the shooting game, the game machine 12 repeatedly performs processing pertaining to steps 110 through 120 at all times. Through use of the direction button 22, the user moves the aiming mark 26 to the neighborhood of the object 24 appearing on the monitor 10. As a result, the aiming mark 26 can be readily aimed at the object 24 or a desired part of the object 24. Accordingly, the game machine 12 according to the embodiment provides the user with a shooting game which enables comfortable aiming action under a situation in which the general-purpose game controller 14 is used.

In the second embodiment, the drawing area 32 (or an aggregate of drawing areas 34) larger than the object 24 is set for an individual object 24. However, the size of the drawing area is not limited to such a size. More specifically, in connection with the game machine 12 according to the second embodiment, the drawing area 32 may be set so as to become equal in size with the object 24, or the drawing areas 34 may be set so as to become equal in size with individual parts of the object 24.

Third Embodiment

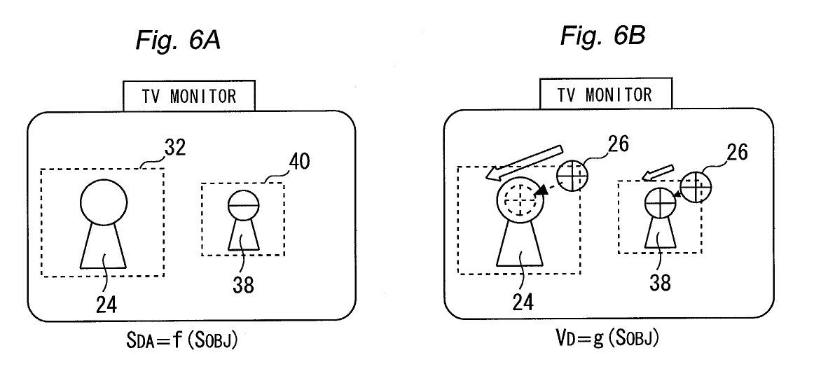

A third embodiment of the present invention will now be described by reference to FIGS. 6A and 6B.

FIGS. 6A and 6B are views for describing characteristics of the shooting game performed by the game machine 12 in the present embodiment. More specifically, FIG. 6A is a view exemplifying a relationship between an area S_{OBJ} occupied by an object and an area S_{DA} of the drawing area on the monitor 10. FIG. 6B is a view exemplifying a relationship between an area S_{OBJ} on the monitor 10 occupied by an object and a speed V_{D} at which the aiming mark 26 is drawn into the area.

The game machine 12 according to the embodiment is characterized in that the attributes of drawing areas assigned to respective objects are set on the basis of areas S_{OBJ} on the monitor 10 occupied by the respective objects. More specifically, as shown in FIG. 6A, an area S_{DA} of a drawing area is determined as a function f (S_{OBJ}) of an area S_{OBJ} occupied by a corresponding object. As shown in FIG. 6B, a drawing speed V_{D} in a drawing area is determined as a function g (S_{OBJ}) of the area S_{OBJ} occupied by a corresponding object. Except for the difference set forth, the game machine 12 according to the present embodiment is identical with those described in connection with the first and second embodiments. There will now be described primarily a method of setting the attributes of a drawing area (the area S_{DA} and the drawing speed V_{D}) on the occupied area S_{OBJ}.

FIG. 6A shows a state in which a large drawing area 32 is set for an object 24 of large occupied area S_{OBJ}, and a small drawing area 40 is set for an object 38 of small occupied area S_{OBJ}. In short, the area S_{DA} of the drawing area is set such that a ratio of the area of the drawing area to the area of the object (S_{DA}/S_{OBJ}) becomes greater with an increase in the area S_{OBJ} of the object.

By means of such a setting, no significant remedy is implemented at the time of aiming at the object 38 displayed small on the monitor 10, and only an operation for aiming at the object 24 appearing large on the monitor 10 can be facilitated. For this reason, the game machine 12 according to the present embodiment ensures a large degree of freedom relating to specifications of a shooting game.

In the above-described embodiment, the large drawing area 32 is set for the large object 24, and the small drawing area 40 is set for the small object 38. The dimensional relationship between an object and a corresponding drawing area is not limited to such an example. Alternatively, a small drawing area may be set for the large object 24, and a large drawing area may be set for the small object 38. This setting enables embodiment of a specification in which no significant remedy is implemented for aiming at the large object 24 and in which primarily an operation for aiming at a small object, which usually involves difficulty in aiming action, is made easy.

FIG. 6B shows a state in which a high drawing speed V_{D} is set for the object 24 of large occupied area S_{OBJ} and a low drawing speed V_{D} is set for the object 38 of small occupied area S_{OBJ}. Such settings enable a specification in which the aiming mark 26 is drawn at high speed onto the object 24 appearing large on the monitor 10 and the aiming mark 26 is drawn slowly onto the object 38 appearing small on the monitor 10. For this reason, the game machine 12 according to the embodiment ensures a large degree of freedom pertaining to specifications of a shooting game. The relationship between the area S_{OBJ} occupied by the object and the drawing speed V_{D} is not limited to the example set forth. Reversal of the settings is possible, as in the case of the relationship between the occupied area S_{OBJ} and the area of the drawing area S_{DA}.

Fourth Embodiment

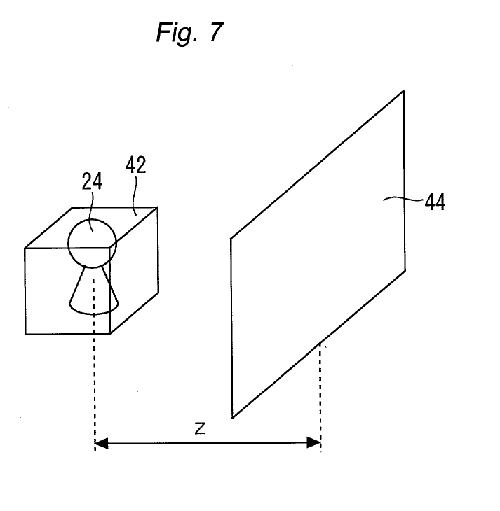

A fourth embodiment of the present invention will now be described by reference to FIG. 7. FIG. 7 is a view for describing a Z value set for the object 24 appearing on the monitor 10. When a three-dimensional image is displayed on the monitor 10 through two-dimensional projection, a position in a depthwise direction; that is, a distance between the object 24 and a virtual screen 44 on which a two-dimensional image is to be projected, is set as a Z value for the object 24 constituting the image.

The game machine 12 produces a three-dimensional image from the thus-set Z value by means of changing the size of the object 24 appearing on the monitor 10. More specifically, the game machine 12 displays the object 24 increasingly larger as the Z value becomes smaller and displays the object 24 increasingly smaller as the Z value becomes larger. In the present embodiment, the area S_{OB} on the monitor 10 occupied by the object 24 can be expressed as a function of the Z value.

In the present embodiment, as shown in FIG. 7, a drawing box 42 is set for each of the objects 24 appearing on the monitor 10. The drawing box 42 is projected on the virtual screen 44, thereby constituting the drawing area 32 described in connection with the first through third embodiments.

The game machine 12 according to the present embodiment is characterized in that attributes of the drawing box 42 are set on the basis of the Z value of each of the objects 24. In the present embodiment, the size of the drawing box 42 is set as a function F(Z) of the Z value of an object. The drawing speed VD in the drawing box 42 (i.e., the drawing area 32) is set as a function G(Z) of the Z value of an object.

The game machine 12 according to the embodiment provides an effect of an operation for drawing an object located at a position near the player in a three-dimensional image to differ from an effect of an operation for drawing an object located at a position distant from the player in the three-dimensional image. Accordingly, the game machine 12 according to the embodiment can ensure a large degree of freedom pertaining to specifications of a shooting game.

Fifth Embodiment

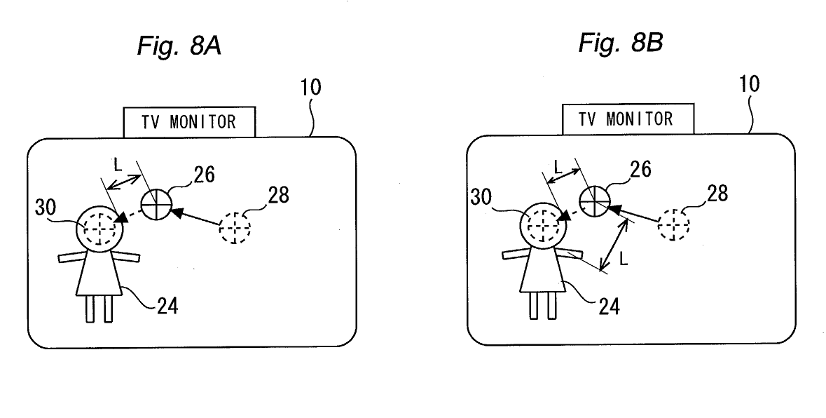

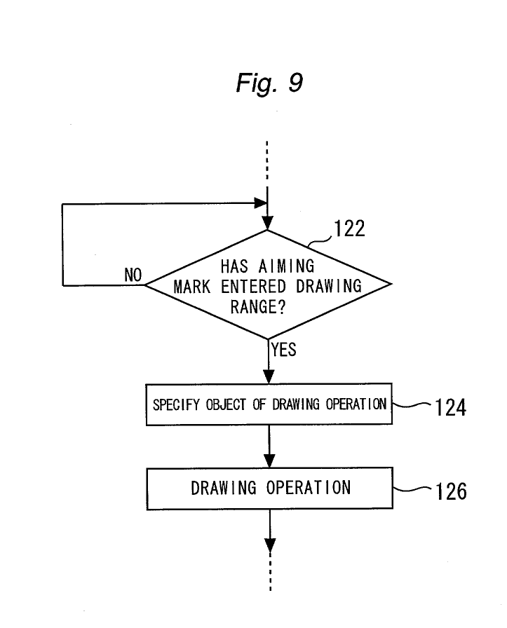

By reference to FIGS. 8A, 8B, and 9, a fifth embodiment of the present invention will now be described.

FIGS. 8A and 8B are views for describing characteristics of a shooting game performed by the game machine 12 according to the present embodiment. More specifically, FIG. 8A is a view for describing a case where single drawing distance is set for a single object 24. FIG. 8B is a view for describing a case where a drawing distance is recognized for a plurality of parts of the object 24, respectively. The game machine 12 can selectively use either the method shown in FIG. 8A or the method shown in FIG. 8B, as required.

The game machine 12 according to the embodiment is characterized in that a determination as to whether to start a drawing operation is made on the basis of a result of a determination as to whether or not a distance L between the aiming mark 26 and the object 24 is shorter than a predetermined drawing distance. FIG. 8A shows an example in which a drawing operation is commenced on the basis of a result of a determination as to whether or not only one distance L that is ascertained in connection with the object 24 is shorter than a drawing distance. FIG. 8B shows an example in which a determination is made as to whether the distance L is shorter than a drawing distance for any of the parts, and in which the aiming mark 26 is drawn to the closest part when the distance L is found to be shorter than the drawing distance of any of the plurality of parts.

FIG. 9 shows a flowchart showing a round of processing steps to be performed by the game machine 12 for implementing the foregoing drawing operation.

As shown in FIG. 9, the game machine 12 determines whether or not the aiming mark 26 has entered a drawing distance of any one of objects (step 122).

If the aiming mark 26 has been determined to have entered a drawing distance, an object toward which the aiming mark 26 is to be drawn or a part of the object is specified (step 124).

As a result of the drawing operation being performed, the aiming mark 26 is automatically drawn to the drawn aiming position 30 corresponding to the thus-specified object (or part).

In the present embodiment, during the course of progress in the shooting game the game machine 12 repeatedly performs processing pertaining to steps 122 through 126. For this reason, the user can readily aim the aiming mark 26 to the object 24 or a desired part of the object 24, by means of moving the aiming mark 26 to the neighborhood of the object 24 appearing on the monitor 10. The game machine 12 according to the present embodiment provides the user with a shooting game which enables comfortable aiming action under which the general-purpose game controller 14 is used.

In the fifth embodiment, a drawing distance to be used for making a determination as to whether to start a drawing operation is described as a predetermined range. However, the drawing distance is not necessarily set to a given distance. In other words, as in the case of the third embodiment, the drawing distance may be embodied as a function of the area S_{OBJ} on the monitor 10 occupied by the object. Alternatively, as in the case of the fourth embodiment, the drawing distance may be embodied as a function of a Z value of a target object 24.

Sixth Embodiment

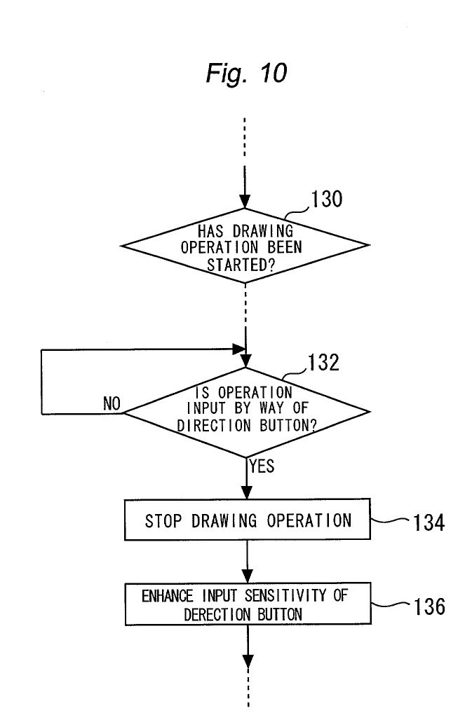

By reference to FIG. 10, a sixth embodiment of the present invention will now be described. FIG. 10 is a flowchart for describing details of a round of processing steps to be performed in association with commencement of drawing operation. The game machine 12 according to the embodiment is embodied by means of causing any one of the game machines 12 described in connection with the first through fifth embodiments to additionally perform the processing shown in FIG. 10.

Through the round of processing steps shown in FIG. 10, a determination is made as to whether or not an operation for drawing the aiming mark 26 has been started (step 130).

If the drawing operation is determined to have been started, another determination is made as to whether or not the direction button 20 of the game controller 14 is being actuated (step 132).

In a case where the direction button 20 is being actuated after the drawing operation has been started, the user can be presumed to have an intention of actuating the aiming mark 26 even after the drawing operation has been started. Therefore, in the present embodiment, when actuation of the direction button 20 is ascertained, the drawing operation is stopped (step 134), and the input sensitivity of the direction button 20 is enhanced (step 136).

By means of the game machine 12 according to the embodiment, the user who has an intention of actuating the aiming mark 26 after the drawing operation has been started can promptly move the aiming mark 26 toward the object 24 or away from the drawing area 32, through use of the direction button 20 whose input sensitivity has been enhanced. In this manner, the game machine 12 according to the embodiment can provide a game which is able to reflect user's intention on the aiming mark 26 even during the course of execution of a drawing operation.

Seventh Embodiment

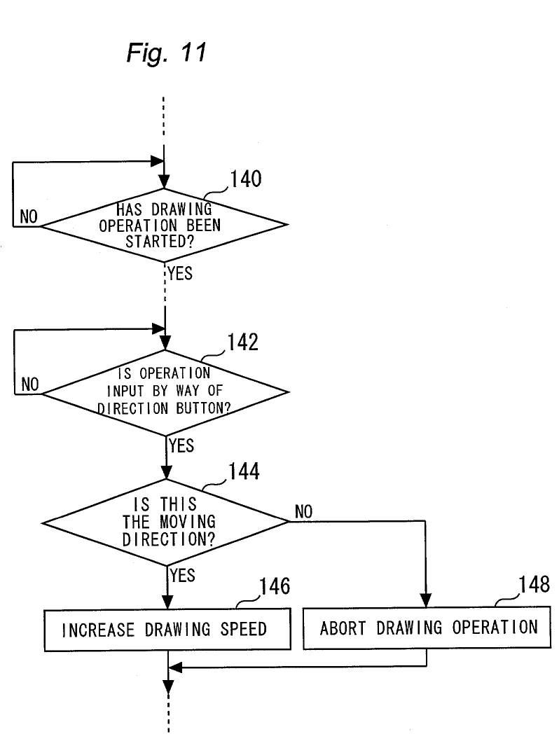

By reference to FIG. 11, a seventh embodiment of the present invention will now be described. FIG. 11 shows a flowchart for describing details of a round of processing steps to be performed in association with commencement of drawing operation. The game machine 12 according to the embodiment is embodied by means of causing any one of the game machines 12 described in connection with the first through fifth embodiments to additionally perform the processing shown in FIG. 11.

Through the round of processing steps shown in FIG. 11, a determination is firstly made as to whether or not an operation for drawing the aiming mark 26 has been started (step 140).

If the drawing operation is determined to have been started, another determination is made as to whether or not the direction button 20 of the game controller 14 is being actuated (step 142).

In a case where the direction button 20 is determined as being actuated, the user can be presumed to have an intention of actuating the aiming mark 26 after the drawing operation has been started. In this case, a determination is made as to whether or not a match exists between the actuation direction of the direction button 20 and the direction in which the aiming mark 26 is moving during the course of the drawing operation (step 144).

If a match is deemed to exist between the actuating direction of the direction button 20 and the moving direction of the aiming mark 26, the user can be presumed to desire to aim the aiming mark 26 at the object as quickly as possible. In this case, the game machine 12 according to the present embodiment performs an operation for increasing the drawing speed V_{D} of the aiming mark 26 (step 146).

If no match is deemed to exist between the actuating direction of the direction button 20 and the moving direction of the aiming mark 26, the user can be presumed to have an intention of moving the aiming mark 26 in a direction differing from the direction in which the aiming mark 26 is to be drawn through drawing operation. In this case, the game machine 12 according to the present embodiment suspends a drawing operation and restores a situation in which the user can freely actuate the aiming mark 26 (step 148).

As mentioned above, the game machine 12 according to the embodiment can increase the drawing speed VD or suspend the drawing operation in accordance with the user's intention after the drawing operation has been started. Hence, as in the case of the sixth embodiment, the game machine 12 according to the embodiment can provide a game which is able to reflect user's intention on the movement of the aiming mark 26 even during the course of a drawing operation.

Eighth Embodiment

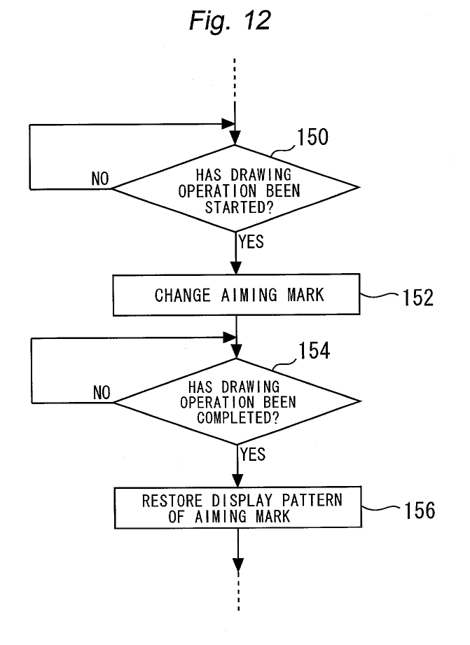

By reference to FIG. 12, an eighth embodiment of the present invention will now be described. FIG. 12 shows a flowchart for describing details of a round of processing steps to be performed in association with commencement of drawing operation. The game machine 12 according to the embodiment is embodied by means of causing any one of the game machines 12 described in connection with the first through seventh embodiments to additionally perform the processing shown in FIG. 12.

Through the round of processing steps shown in FIG. 12, a determination is made as to whether or not an operation for drawing the aiming mark 26 has been started (step 150).

If the drawing operation is determined to have been started, a display pattern of the aiming mark 26; that is, the color or shape of the aiming mark 26, is changed (step 152).

Subsequently, a determination is made as to whether or not the drawing operation has been completed (step 154).

In conjunction with completion of the drawing operation, the display pattern of the aiming mark 26 is restored to its original pattern (step 156).

In the present embodiment, as a result of the previous processing, the display pattern of the aiming mark 26 is changed only during the course of the drawing operation being performed. As a result, the game machine 12 according to the embodiment enables the user to readily and visually ascertain the start and end of the drawing operation.

In the eighth embodiment, the display pattern of the aiming mark 26 is changed only during the course of a drawing operation. However, the display pattern of the aiming mark 26 may be changed when the aiming mark 26 is located at a drawable position even when the drawing operation has not actually started. More specifically, the display pattern of the aiming mark 26 may be changed when the aiming mark 26 is present in the drawing area or when a distance between the aiming mark 26 and an object is shorter than the drawing distance.

For the sake of convenience, the descriptions relating to the first through seventh embodiments use the terms “firing” and “bullet.” However, that which is fired toward an object in the present invention is not limited to a bullet, and may correspond to anything analogous thereto.

The first through seventh embodiments have described examples in which the image processing apparatus according to the present invention is applied to a shooting game, application of the present invention is not limited to a shooting game. For instance, the present invention may be used for facilitating an operation for indicating an icon or the like appearing on a monitor with a pointer.

The first through seventh embodiments have described that the drawing operation is performed at all times; however, the present invention is not limited to these embodiments. A determination as to whether to execute a drawing operation may be left up to the user. More specifically, the image processing apparatus according to the present invention may be set in such a manner that the user can select either a mode for executing a drawing operation or a mode for not executing a drawing operation. Alternatively, a drawing request button or the like may be provided on a controller, and a request to selection whether or not to perform a drawing operation may be given to user every time an individual instruction operation is performed.

The user may select whether or not to determine start of a drawing operation by means of the method described in connection with the first embodiment or that described in connection with the second embodiment. Moreover, the user may select whether or not to set attributes of a drawing area by means of the method described in connection with the third embodiment or that described in connection with the fourth embodiment. Similarly, the user may select either the method described in connection with the sixth embodiment or that described in connection with the seventh embodiment, as a method of causing his intention to be reflected on a pointing mark during the course of a drawing operation.

As has been described, when a pointing mark appearing on a monitor is actuated toward a desired object up to the neighborhood thereof, the pointing mark can be automatically drawn into the position where the mark aims at the object. For this reason, the present invention facilitates an operation for aiming a pointing mark at the object.

Further, the present invention is not limited to these embodiments, but variations and modifications may be made without departing from the scope of the present invention.

The entire disclosure of Japanese Patent Application No. 2001-079231 filed on Mar. 19, 2001 including specification, claims, drawings and summary are incorporated herein by reference in its entirety.

What is claimed is

1. An image processing apparatus comprising:
object display means for displaying an object on a monitor;
means for displaying a pointing mark on the monitor;
means for moving the position of the pointing mark on the monitor in accordance with a movement instruction output from a controller;
determination means for determining, on the basis of movement of the pointing mark, whether or not the pointing mark is actuated toward the object; and
drawing means for drawing the pointing mark to a drawing position which links with the object when the pointing mark is determined to have been actuated toward the object.

2. The image processing apparatus according to claim 1, further comprising:
means for handling the position of the pointing mark as a hit position upon an instruction output from the controller; and
means for determining whether or not the object has been hit, on the basis of the hit position, wherein
said drawing position which links with the object is a position where the object can be hit.

3. The image processing apparatus according to claim 1, wherein said drawing position which links with the object is a position which overlaps with the object on the monitor.

4. The image processing apparatus according to claim 1, further comprising:
means for setting a drawing area of predetermined size around the object, wherein
said determination means comprises
means for determining whether or not the pointing mark has entered the drawing area; and
means for judging that the pointing mark is actuated toward the object if the pointing mark is determined to have entered the drawing area.

5. The image processing apparatus according to claim 1, further comprising:
means for setting a drawing area corresponding to the object, and wherein
the determination means comprises
means for computing an extension vector representing a predicted moving direction of the pointing mark from the trail of the pointing mark;
means for determining whether or not the extension vector has entered the drawing area; and
means for judging that the pointing mark is actuated toward the object if the extension vector has been determined to have entered the drawing area.

6. The image processing apparatus according to claim 4, wherein
said drawing area is set so as to correspond to each of parts of the object, and
said drawing means draws the pointing mark into parts corresponding to respective drawing areas.

7. The image processing apparatus according to claim 4, wherein the object is displayed on a monitor as a constituent element in a three-dimensional virtual space; and further comprising
means for acquiring a Z value representing position of the object in a depthwise direction within the three-dimensional virtual space; and
means for setting attributes of a drawing area corresponding to the object on the basis of the Z value.

8. The image processing apparatus according to claim 4, further comprising:
means for acquiring an area on the monitor occupied by the object; and
means for setting attributes of the drawing area corresponding to the object on the basis of the occupied area.

9. The image processing apparatus according to claim 7, wherein said attributes of the drawing area include at least one of the size of the drawing area and a speed at which the pointing mark is drawn within the drawing area.

10. The image processing apparatus according to claim 1, further comprising:
means for changing moving sensitivity of the pointing mark to the movement instruction, during the course of a drawing operation being performed by the drawing means.

11. The image processing apparatus according to claim 1, further comprising:
means for increasing a drawing speed of the pointing mark when, during the course of a drawing operation being performed by the drawing means, there is issued a moving instruction which requires acceleration of movement of the pointing mark.

12. The image processing apparatus according to claim 1, further comprising:
means for aborting the drawing operation when, during the course of a drawing operation being performed by the drawing means, there is issued a movement instruction toward a direction in which movement of the pointing mark is hindered.

13. The image processing apparatus according to claim 1, further comprising:
means for changing a display pattern of the pointing mark between a pattern displayed when the drawing means is performing a drawing operation and a pattern displayed when the drawing means is not performing a drawing operation.

14. The image processing apparatus according to claim 1, further comprising:
means for selectively rendering the drawing means valid or invalid in accordance with an instruction output from the controller.

15. An image processing program comprising a program for causing a computer to perform:
object display processing for displaying an object on a monitor;
processing for displaying a pointing mark on the monitor;
processing for moving the position of the pointing mark on the monitor in accordance with a movement instruction output from a controller;
determination processing for determining, on the basis of movement of the pointing mark, whether or not the pointing mark is actuated toward the object; and
drawing processing for drawing the pointing mark to a drawing position which links with the object when the pointing mark is determined as being actuated toward the object.

16. The image processing program according to claim 15, further comprising a program for causing a computer to perform:
processing for handling the position of the pointing mark as a hit position upon an instruction output from the controller; and
processing for determining whether or not the object has been hit, on the basis of the hit position, wherein
the drawing position which links with the object is a position where the object can be hit.

17. The image processing program according to claim 15, wherein said drawing position which links with the object is a position which overlaps with the object on the monitor.

18. The image processing program according to claim 15, further comprising:
a program for setting a drawing area of predetermined size around the object, wherein
the determination processing comprises
processing for determining whether or not the pointing mark has entered the drawing area; and
processing for judging that the pointing mark is actuated toward the object if the pointing mark is determined to have entered the drawing area.

19. The image processing program according to claim 15, further comprising:
a program for setting a drawing area corresponding to the object, and wherein
the determination processing comprises
processing for computing an extension vector representing a predicted moving direction of the pointing mark from the trail of the pointing mark;
processing for determining whether or not the extension vector has entered the drawing area; and
processing for judging that the pointing mark is actuated toward the object if the extension vector has been determined to have entered the drawing area.

20. The image processing program according to claim 18, wherein the drawing area is set so as to correspond to each of parts of the object, and the drawing processing involves drawing of the pointing mark into parts corresponding to respective drawing areas.

21. The image processing program according to claim 18, wherein the object is displayed on a monitor as a constituent element in a three-dimensional virtual space; and further comprising a program for causing a computer to perform
processing for acquiring a Z value representing position of the object in a depthwise direction within the three-dimensional virtual space; and
processing for setting attributes of a drawing area corresponding to the object on the basis of the Z value.

22. The image processing program according to claim 18, further comprising a program for causing a computer to perform:
processing for acquiring an area on the monitor occupied by the object; and
processing for setting attributes of the drawing area corresponding to the object on the basis of the occupied area.

23. The image processing program according to claim 21, wherein said attributes of the drawing area include at least one of the size of the drawing area and a speed at which the pointing mark is drawn within the drawing area.

24. The image processing program according to claim 15, further comprising a program for causing a computer to perform processing for changing moving sensitivity of the pointing mark to the movement instruction, during the course of the drawing processing.

25. The image processing program according to claim 15, further comprising a program for causing a computer to perform processing for increasing a drawing speed of the pointing mark when, during the course of the drawing processing, there is issued a moving instruction which requires acceleration of movement of the pointing mark

26. The image processing program according to claims 15, further comprising a program for causing a computer to perform processing for aborting the drawing operation when, during the course of the drawing processing, there is issued a movement instruction toward a direction in which movement of the pointing mark is hindered

27. The image processing program according to claim 15, further comprising a program for causing a computer to perform processing for changing a display pattern of the pointing mark between a pattern displayed when the drawing processing is performed and a pattern displayed when the drawing processing is not performed.

28. The image processing program according to claim 15, further comprising a program for causing a computer to perform processing for selectively rendering the drawing processing valid or invalid in accordance with an instruction output from the controller.

29. A computer-readable recording medium having recorded thereon the image processing program defined in claim 15.
